(19) United States
(12) Patent Application Publication
(10) Pub. No.: US 2016/0057683 A1
(43) Pub. Date: Feb. 25, 2016

(54) CELL CHANGE ORDER AND CELL RESELECTION BY A WIRELESS DEVICE

(71) Applicant: QUALCOMM Incorporated, San Diego, CA (US)

(72) Inventors: Ming YANG, San Diego, CA (US); Tom CHIN, San Diego, CA (US)

(21) Appl. No.: 14/466,560

(22) Filed: Aug. 22, 2014

(51) Int. Cl. H04W 36/24

(52) U.S. Cl. CPC H04W 36/24

(57) ABSTRACT

A method and/or apparatus for wireless communication in a multi-SIM user equipment includes receiving a list of neighboring base stations from a serving base station of a first SIM. The serving base station of a second SIM is identified and a final target base station is determined for a cell reselection procedure and/or cell change order procedure from among the neighboring base stations and the serving base station of the second SIM.

### BACKGROUND

1. Field

Aspects of the present disclosure relate generally to wireless communication systems, and more particularly, to cell reselection by a wireless device in a time division—synchronous code division multiple access (TD-SCDMA) network.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the universal terrestrial radio access network (UTRAN). The UTRAN is the radio access network (RAN) defined as a part of the universal mobile telecommunications system (UMTS), a third generation (3G) mobile phone technology supported by the 3rd Generation Partnership Project (3GPP). 3G mobile networks were preceded by second generation (2G) mobile networks based on the GSM standard. 2G mobile networks are still used in many parts of the world.

The UMTS, which is the successor to global system for mobile communications (GSM) technologies, currently supports various air interface standards, such as wideband-code division multiple access (W-CDMA), time division—code division multiple access (TD-CDMA), and time division—synchronous code division multiple access (TD-SCDMA). For example, China is pursuing TD-SCDMA as the underlying air interface in the UTRAN architecture with its existing GSM infrastructure as the core network. The UMTS also supports enhanced 3G data communications protocols, such as high speed packet access (HSPA) and time division high speed packet access (TD-HSPA), which provide higher data transfer speeds and capacity to associated UMTS networks. HSPA is a collection of two mobile telephony protocols, high speed downlink packet access (HSDPA) and high speed uplink packet access (HSUPA), which extends and improves the performance of existing wideband protocols.

These multiple access technologies have been adopted in various telecommunication standards to provide a common protocol that enables different wireless devices to communicate on a municipal, national, regional, and even global level. An example of an emerging telecommunication standard is long term evolution (LTE). LTE is a set of enhancements to the universal mobile telecommunications system (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. The radio access network supporting LTE is called the enhanced universal terrestrial radio access network (EUTRAN) in which the LTE air interface is referred to as enhanced universal terrestrial radio access (EUTRA).

As the demand for mobile broadband access continues to increase, research and development continue to advance the UMTS and LTE technologies not only to meet the growing demand for mobile broadband access, but to advance and enhance the user experience with mobile communications.

Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

### SUMMARY

In one aspect, a method of wireless communication is disclosed. The method includes receiving a list of neighboring base stations from a serving base station of a first SIM. The method also includes identifying a serving base station of a second SIM. Additionally, the method includes determining a final target base station for a cell reselection procedure and/or cell change order procedure from among the neighboring base stations and the serving base station of the second SIM.

Another aspect discloses an apparatus including means for receiving a list of neighboring base stations from a serving base station of a first SIM. The apparatus also includes means for identifying a serving base station of a second SIM. Additionally, the apparatus includes means for determining a final target base station for a cell reselection procedure and/or cell change order procedure from among the neighboring base stations and the serving base station of the second SIM.

Another aspect discloses wireless communication having a memory and at least one processor coupled to the memory. The processor(s) is configured to receiving a list of neighboring base stations from a serving base station of a first SIM. The processor(s) is also configured to identify a serving base station of a second SIM. Additionally, the processor(s) is also configured to determine a final target base station for a cell reselection procedure and/or cell change order procedure from among the neighboring base stations and the serving base station of the second SIM.

In another aspect, a computer program product for wireless communications in a wireless network having a non-transitory computer-readable medium is disclosed. The computer readable medium has non-transitory program code recorded thereon which, when executed by the processor(s), causes the processor(s) to perform operations of receiving a list of neighboring base stations from a serving base station of a first SIM. The program code also causes the processor(s) to identify a serving base station of a second SIM. Additionally, the program code also causes the processor(s) determine a final target base station for a cell reselection procedure and/or cell change order procedure from among the neighboring base stations and the serving base station of the second SIM.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 illustrates network coverage areas according to aspects of the present disclosure.

FIG. 5 is a flow diagram illustrating a method for cell reselection according to one aspect of the present disclosure.

FIG. 6 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

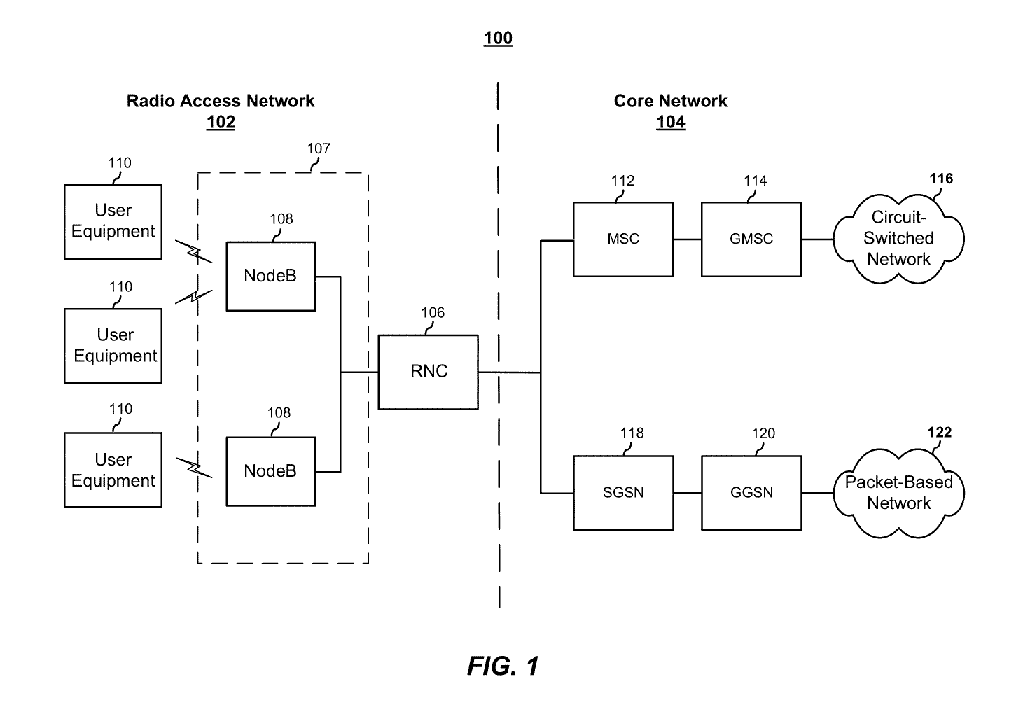

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of radio network subsystems (RNSs) such as an RNS 107, each controlled by a radio network controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The core network may also support Exchanged Data Rates for GSM Evolution (EDGE) services which are based on the GPRS system and are configured for heavy mobile data transmission.

The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

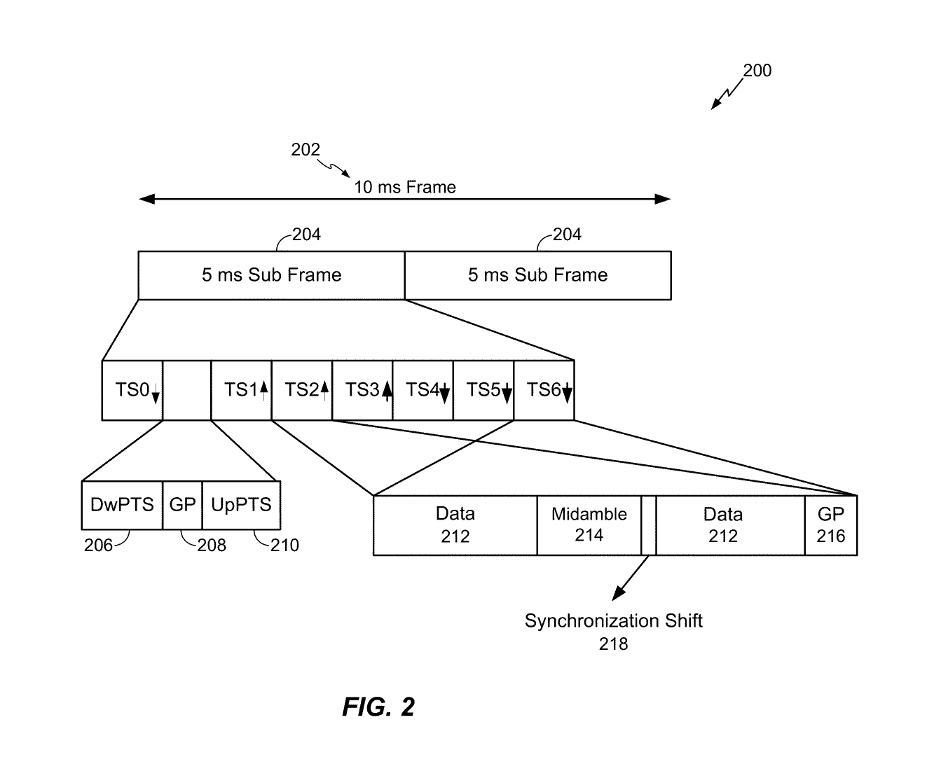

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including synchronization shift (SS) bits 218. Synchronization shift bits 218 only appear in the second part of the data portion. The synchronization shift bits 218 immediately following the midamble can indicate three cases: decrease shift, increase shift, or do nothing in the upload transmit timing. The positions of the synchronization shift bits 218 are not generally used during uplink communications.

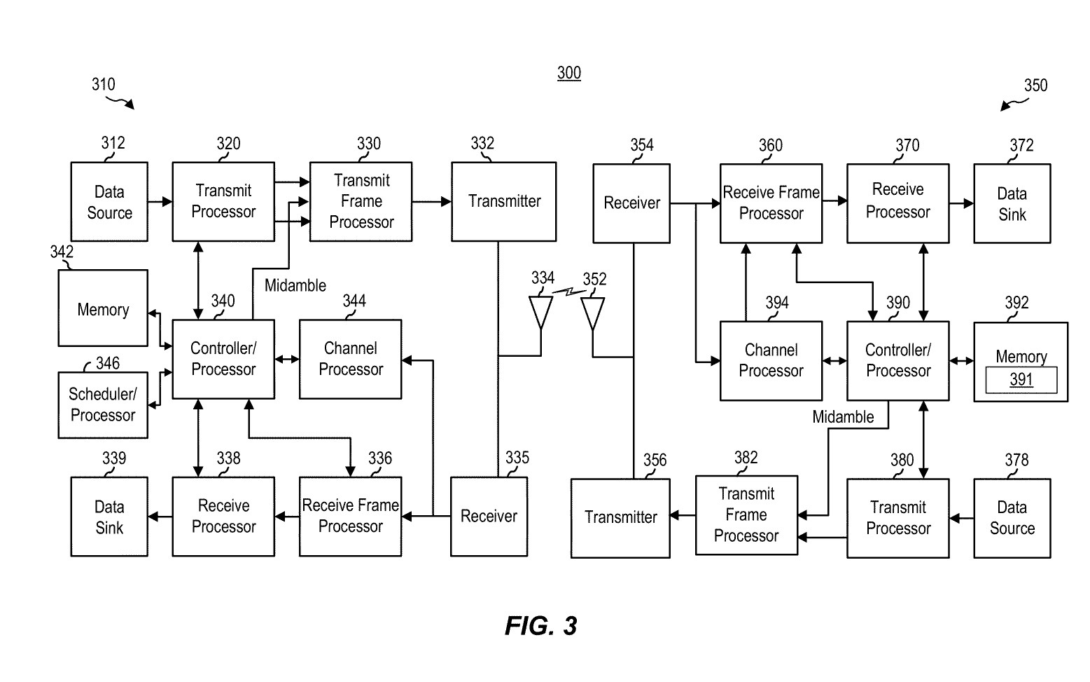

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receive processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer-readable media of memories 342 and 392 may store data and software for the node B 310 and the UE 350, respectively. For example, a non-transitory portion of the memory 392 of the UE 350 may store cell reselection module 391 which, when executed by the controller/processor 390, configures the UE 350 to perform cell reselection.

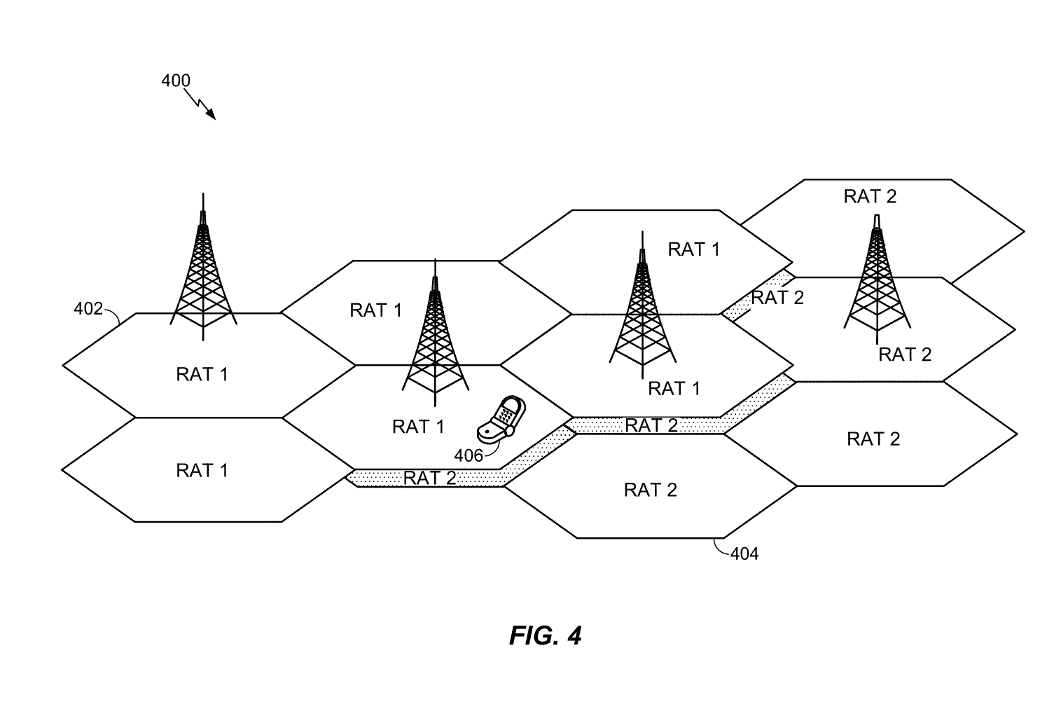

Some networks, such as a newer or newly deployed network, may cover only a portion of a geographical area. Another network, such as an older more established network, may better cover the area, including remaining portions of the geographical area. FIG. 4 illustrates coverage of an established network utilizing a first type of radio access technology (RAT-1), such as, but not limited to, a TD-SCDMA network, and also illustrates a newly deployed network utilizing a second type of radio access technology (RAT-2), such as, but not limited to, a Long Term Evolution (LTE) network.

The geographical area 400 may include RAT-1 cells 402 and RAT-2 cells 404. This arrangement of overlapping cells of different RATs may apply to various combinations of RAT technologies, and in some cases, the cells of more than two RATs may be overlaid in a same geographic area (e.g., overlapping GSM, TD-SCDMA, and LTE cells in a same geographic location). A user equipment (UE) may move from one cell, such as a RAT-1 cell 402, to another cell, such as a RAT-2 cell 404. The movement of the UE may specify a handover or a cell reselection.

The handover or cell reselection may be performed when the UE moves from a coverage area of a first RAT to the coverage area of a second RAT, or vice versa. A handover or cell reselection may also be performed, among other reasons, when there is a coverage hole or lack of coverage in one network or when there is traffic balancing between a first RAT and the second RAT networks. As part of that handover or cell reselection process, while in a connected mode with a first system (e.g., TD-SCDMA) a UE may be specified to perform a measurement of a neighboring cell (such as an LTE cell). For example, the UE 350 may measure the neighbor cells of a second network for signal strength, frequency channel, and base station identity code (BSIC). The UE may then connect to the strongest cell of the second network. Such measurement may be referred to as inter radio access technology (IRAT) measurement.

The UE 350 may send a serving cell a measurement report indicating results of the IRAT measurement performed by the UE. The serving cell may then trigger a handover of the UE 350 to a new cell in the other RAT based on the measurement report. The measurement may include a serving cell signal strength, such as a received signal code power (RSCP) for a pilot channel (e.g., primary common control physical channel (PCCPCH)). The signal strength is compared to a serving system threshold. The serving system threshold can be indicated to the UE 350 through dedicated radio resource control (RRC) signaling from the network. The measurement may also include a neighbor cell received signal strength indicator (RSSI). The neighbor cell signal strength can be compared with a neighbor system threshold. Before handover or cell reselection, in addition to the measurement processes, the base station IDs (e.g., BSICs) are confirmed and re-confirmed.

Handover from the first RAT to the second RAT may be based on event measurement reporting. Events triggering an inter-RAT handover may include a UMTS cell quality moving below a threshold and a GSM cell quality moving above a threshold (called an e3a event), a GSM cell quality moving below a threshold (called an e3b event), a GSM cell quality moving above a threshold (called an e3c event), or a change in the order of best GSM cell list (called an e3d event).

In one configuration, the event measurement reporting may be triggered based on filtered measurements of the first RAT and the second RAT, a base station identity code (BSIC) confirm procedure of the second RAT and also a BSIC re-confirm procedure of the second RAT. For example, a filtered measurement may be a primary common control physical channel (P-CCPCH) or a primary common control physical shared channel (P-CCPSCH) received signal code power (RSCP) measurement of a serving cell. Other filtered measurements can be of a received signal strength indication (RSSI) of a cell of the second RAT.

The initial BSIC identification procedure occurs because there is no knowledge of the relative timing between a cell of the first RAT and a cell of the second RAT. The initial BSIC identification procedure includes searching for the BSIC and decoding the BSIC for the first time. The UE may trigger the initial BSIC identification within available idle time slot(s) when the UE is in a dedicated channel (DCH) mode configured for the first RAT.

A user equipment (UE) may include more than one subscriber identity module (SIM) or universal subscriber identity module (USIM). A UE with more than one SIM may be referred to as a multi-SIM device. In the present disclosure, a SIM may refer to a SIM or a USIM. Each SIM may also include a unique international mobile subscriber identity (IMSI) and service subscription information. Each SIM may be configured to operate in a particular radio access technology. Moreover, each SIM may have full phone features and be associated with a unique phone number. Therefore, the UE may use each SIM to send and receive phone calls. That is, the UE may simultaneously communicate via the phone numbers associated with each individual SIM. For example, a first SIM card can be associated for use in a City A and a second SIM card may be associated for use in a different City B to reduce roaming fees and long distance calling fees. Alternately, a first SIM card may be assigned for personal usage and a different SIM card may be assigned for work/business purposes. In another configuration, a first SIM card provides full phone features and a different SIM card is utilized mostly for data services.

Many multi-SIM devices support multi-SIM multi-standby operation using a single radio frequency (RF) chain to transmit and receive communications. In one example, a multi-SIM device includes a first SIM dedicated to operate in first RAT and a second SIM dedicated to operate in a second RAT. In one illustrative example, the multi-SIM device includes a first SIM configured to operate in GSM (i.e., G subscription) and a second SIM configured to operate in TD-SCDMA (i.e., T subscription). When the T subscription is in the dedicated channel (DCH) state without voice traffic, the multi-SIM device supports the TD-SCDMA to GSM tune away with the least amount of interruption to the TD-SCDMA DCH operation. When the UE is in the TD-SCDMA dedicated channel, the UE periodically tunes away from TD-SCDMA, and tunes to GSM to monitor for pages. If the G subscription detects a page when the T to G tune away is active, the multi-SIM UE suspends all operations of the TD-SCMA subscription and transitions to another RAT. If the other RAT subscription does not detect a page, the UE tunes back to TD-SCDMA and attempts to recover to the original operation of the TD-SCDMA subscription. The multi-SIM device may operate in other RATS known to those skilled in the art.

Some smartphones are capable of communicating using simultaneous GSM and LTE (SG-LTE) technologies. Techniques for SG-LTE communication provide multi-mode LTE/TD-SCDMA (TD-HSPA) and GSM (GPRS/EDGE) dual-standby dual-active single-USIM capability. The SG-LTE uses GSM for voice and LTE for data where LTE is available, and uses TD-SCDMA for data where LTE is not available.

Some 2G or 3G cells may not properly configure IRAT neighbor information or open a measurement GAP for LTE neighbor cells. This may prevent a UE from performing a cell re-selection such as a standard cell change order (CCO) or handover from a GSM to EUTRA cell or from a TD-SCDMA to EUTRA cell, for example. Thus, a UE may maintain a connection on a relatively slow 2G or 3G cell even when a strong LTE signal may be available for faster communication.

Serving RAT cells may not configure IRAT neighbor information properly. For example, some 2G or 3G cells may not be configured to provide LTE neighbor cell information because the cost of software and hardware upgrades to their corresponding legacy network (GERAN or UTRAN) for providing LTE neighbor information may not be justified. In other 2G or 3G cells, IRAT information for a EUTRA neighbor cell may be obsolete or missing in a corresponding 2G or 3G RAN due to network planning inaccuracies, for example. Changing network topology experienced during initial LTE network deployment may also result in newly added EUTRA coverage information to be missing from certain neighbor cells or co-located GSM or TD-SCDMA cells, for example.

Even within a single RAT, neighbor information provided by a network to the wireless device may include errors or may not include information for one or more strong neighbor cells. In a multi-SIM device, either SIM or both SIMS may receive erroneous or incomplete neighbor information from a network via their respective serving cell. The UE that receives erroneous or incomplete neighbor information may then be commanded to reselect to an improper target RAT cell. This may then result in a failure of the cell change order. In another example, a UE may receive neighbor information from its serving cell including a list of neighbor cells which does not include one or more neighbor cells that could provide better signal strength and/or signal quality than the listed neighbor cells. This may cause the UE to reselect to a neighbor cell with signal strength and/or signal quality that is not as good as another neighbor cell.

### Cell Reselection by a Multi-SIM Device

In a multi-SIM device, a first SIM may receive neighbor information from its serving cell in which a list of neighbor cells does not include one or more neighbor cells that could provide better strength or signal quality than the listed neighbor cells. While the first SIM considers the list of neighbor cells in preparation for performing a cell reselection procedure, a second SIM on the multi-SIM device may be served by a serving cell that provides a stronger signal and/or better signal quality than each of the listed neighbor cells in the neighbor information provided to the first SIM by its serving cell. In this situation, the first SIM may select one of the listed neighbor cells which has a weaker signal or inferior signal quality compared to the cell serving the second SIM on the multi-SIM device. This may substantially diminish performance of the multi-SIM device.

According to an aspect of the present disclosure, a first SIM of a multi-SIM device performs cell reselection by considering a serving cell of second SIM of the multi-SIM device as a potential reselection target along with each neighbor cell listed in the neighbor information provided by the serving cell of the first SIM.

A serving radio access technology (RAT) network may move a UE to a target RAT cell by performing a blind cell change order without UE measurement on the target RAT. In this respect, a cell change order procedure is unlike a handover procedure in which radio resources are reserved for the UE in the target cell. This may result in cell reselection failures and/or cell change order failures.

Aspects of the present disclosure are directed to reducing cell change order failures and cell reselection failures in a multi-SIM device. In particular, the multi-SIM device includes at least two SIMs. The first SIM of the multi-SIM device receives a neighbor list from the serving RAT network of the first SIM. In some instances, the serving RAT cell of a second SIM in the multi-SIM device is not included in a neighbor list. The first SIM may also receive a cell change order indicating a first target cell for reselection and may compare the first target cell to the serving cell of the second SIM of the multi-SIM device. If the serving cell of the second SIM has better a better signal metric than the first target cell, the first SIM may perform reselection to the serving cell of the second SIM instead of to the first target cell (which was indicated in the cell change order). Those skilled in the art will appreciate that the term signal metric may include any type of metric used to evaluate a signal, such as, but not limited to signal strength and signal quality.

According to another aspect of the present disclosure, the first SIM may perform reselection to the serving cell of the second SIM only if the serving cell of the second SIM has a better signal metric (e.g., signal strength, quality, rank etc.) exceeding a predefined offset as compared to the first target cell. If the first target cell has a better signal metric than the serving cell of the second SIM, the first SIM performs reselection to the first target cell as indicated in the cell change order. For example, if the first target cell has a better signal quality and/or signal strength then serving cell of the second SIM, then the first SIM performs reselection to the first target cell.

According to another aspect of the present disclosure, when a multi-SIM devices leaves the serving RAT coverage of a first SIM of the multi-SIM device, the multi-SIM device performs a cell reselection process in which a signal metric (e.g., signal strength, quality and/or rank) of a first serving cell of the first SIM of a multi-SIM device is compared to a signal metric of a second serving cell serving a second SIM of the same multi-SIM device. The signal metric of a first serving cell is also compared to the a list of potential reselection targets, which the first SIM receives from a RAT network via the first serving cell. In other words, the second serving cell that is serving the second SIM is added to the list of potential reselection targets, which the first SIM receives from a RAT network via the first serving cell.

According to an aspect of the present disclosure, if the serving cell of the second SIM has a signal metric (e.g., signal strength, quality and/or rank) better than the serving cell of the first SIM and better than each cell listed in the list of potential reselection targets received from the RAT network by the first SIM, the first SIM may perform reselection to the serving cell of the second SIM. According to another aspect of the present disclosure, the first SIM may perform reselection to the serving cell of the second SIM only if the serving cell of the second SIM has a better signal metric (e.g., signal strength, quality, and/or rank) exceeding a predefined offset as compared to the serving cell of the first SIM and each cell listed in the list of potential reselection targets received from the RAT network by the first SIM. If the serving cell of any of the cells listed in the list of potential reselection targets received from the RAT network by the first SIM has a better signal quality (e.g., signal strength and/or signal quality) exceeding a predefined offset compared to the first serving cell serving the first SIM and the second serving cell serving the second SIM, then the first SIM performs reselection to the first target cell as indicated in the cell change order.

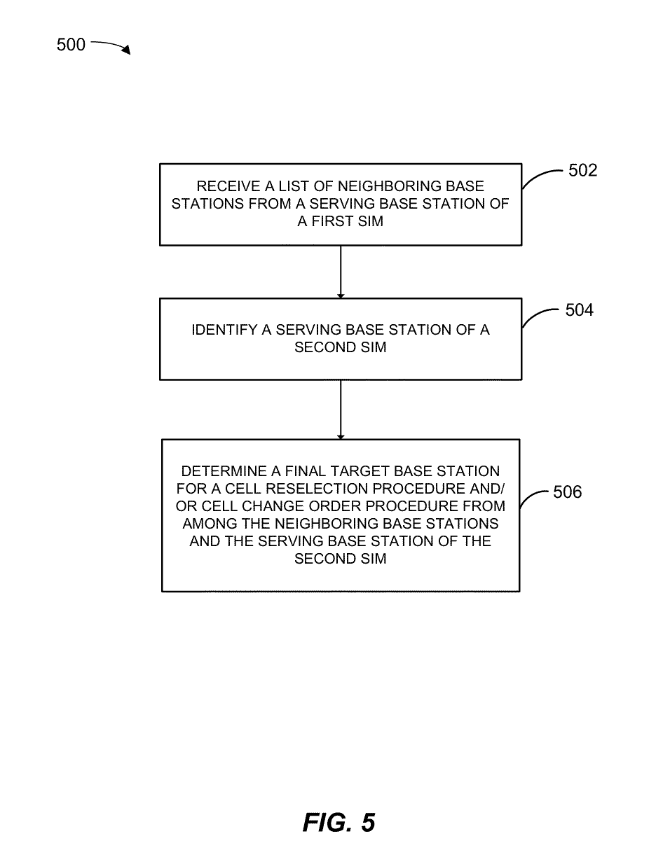

FIG. 5 shows a wireless communication method 500 by a UE having multi-SIM capability according to one aspect of the disclosure. The method includes receiving a list of neighboring base stations from a serving base station of a first SIM, as shown in block 502. A serving base station of a second SIM is then identified, as shown in block 504. In block 506, a final target base station is determined for a cell reselection procedure and/or cell change order procedure from among the neighboring base stations and the serving base station of the second SIM, as shown in block 506.

According to another aspect of the present disclosure, the serving base station of the second SIM is added to the list of neighboring base stations of the first SIM.

Additionally, in another aspect of the present disclosure, a candidate target base station may be received from the serving base station of the first SIM in a cell change order, in which the target base station is different from the serving base station of the second SIM. A first signal metric (e.g., signal strength, quality and/or rank) of the candidate target base station is compared to a second signal metric of the serving base station of the second SIM. The candidate target base station is then selected as the final target base station in response to the first signal metric being greater than the second metric. Or alternately, the serving base station of the second SIM is selected as the final target base station in response to the first signal metric being less than the second signal metric.

In another aspect, the cell reselection method includes selecting a candidate target base station by a UE in a cell reselection process, in which the candidate target base station is different from the serving base station of the second SIM. This method includes comparing a first signal metric of the candidate target base station to a second signal metric of the serving base station of the second SIM and determining the candidate target base station as the final target base station in response to the first signal metric being greater than the second signal metric, or selecting the serving base station of the second SIM as the final target base station in response to the first signal metric being less than the second signal metric. The metric may be a signal strength, rank, and/or priority level, for example. According to an aspect of the present disclosure, the neighboring base stations and the serving base station of the second SIM may be in a first RAT and the serving base station of the first SIM may be in a second RAT, for example. The first RAT may be the same as the second RAT or the first RAT may be different from the second RAT.

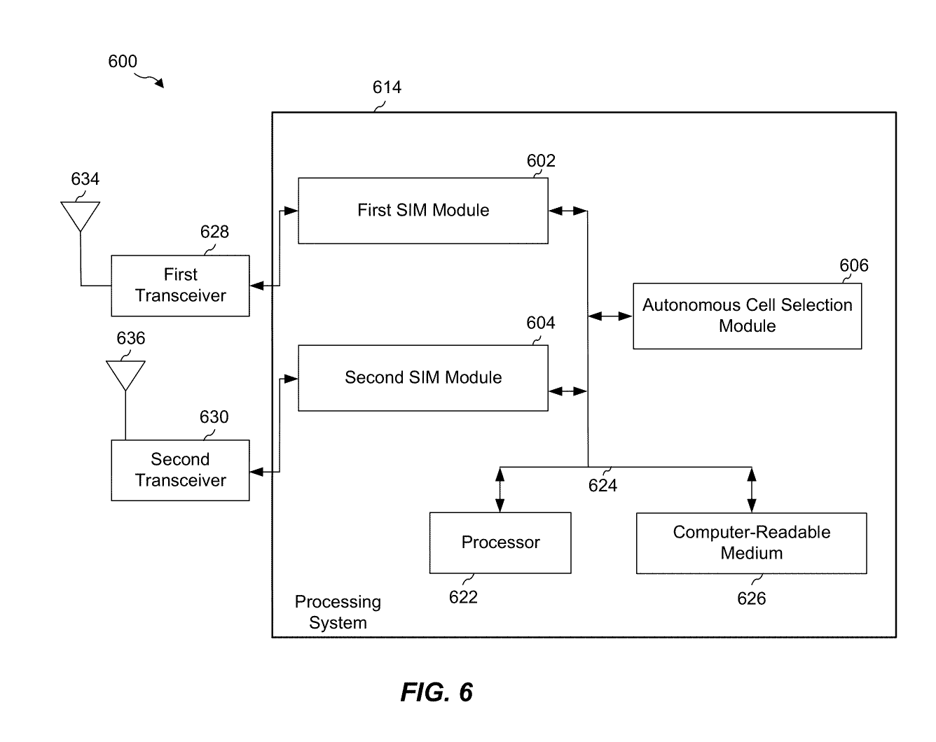

FIG. 6 is a diagram illustrating an example of a hardware implementation for an apparatus 600 employing a processing system 614. The processing system 614 may be implemented with a bus architecture, represented generally by the bus 624. The bus 624 may include any number of interconnecting buses and bridges depending on the specific application of the processing system 614 and the overall design constraints. The bus 624 links together various circuits including one or more processors and/or hardware modules, represented by the processor 622 the modules 602, 604, 606 and the non-transitory computer-readable medium 626. The bus 624 may also link various other circuits such as timing sources, peripherals, voltage regulators, and power management circuits, which are well known in the art, and therefore, will not be described any further.

The apparatus includes a processing system 614 coupled to a first transceiver 628 and a second transceiver 630. The first transceiver 628 is coupled to one or more antennas 634 and second transceiver 630 is coupled to one or more antennas 636. The first transceiver 628 and the second transceiver 630 enable communicating with various other apparatus over a transmission medium. The processing system 614 includes a processor 622 coupled to a non-transitory computer-readable medium 626. The processor 622 is responsible for general processing, including the execution of software stored on the computer-readable medium 626. The software, when executed by the processor 622, causes the processing system 614 to perform the various functions described for any particular apparatus. The computer-readable medium 626 may also be used for storing data that is manipulated by the processor 622 when executing software.

The processing system 614 includes a first SIM module 602 configured for performing communications via the first transceiver 628, including receiving a list of neighboring base stations. The processing system 614 also includes and a second SIM module 604 configured for performing communications via the second transceiver 630. The processing system 614 includes an autonomous cell selection module 606 configured to determine a final target base station for cell reselection. The modules may be software modules running in the processor 622, resident/stored in the computer-readable medium 626, one or more hardware modules coupled to the processor 622, or some combination thereof. The processing system 614 may be a component of the UE 350 and may include the memory 392, and/or the controller/processor 390.

In one configuration, an apparatus such as a UE 350 is configured for wireless communication including means for receiving. In one aspect, the receiving means may be the antennas 352, the receiver 354, the channel processor 394, the receive frame processor 360, the receive processor 370, the controller/processor 390, the memory 392, cell reselection module 391, first SIM module 602, and/or the processing system 614 configured to perform the receiving means. The UE is also configured to include means for identifying. In one aspect, the identifying means may be the antennas 352, the receiver 354, the channel processor 394, the receive frame processor 360, the receive processor 370, the transmitter 356, the transmit frame processor 382, the transmit processor 380, the controller/processor 390, the memory 392, cell reselection module 391, first SIM, second SIM module 604 and/or the processing system 614 configured to perform the identifying means. In one configuration, an apparatus such as a UE is configured for wireless communication including means for determining. In one aspect, the determining means may be the controller/processor 390, the memory 392, cell reselection module 391, first SIM module 602, second SIM module 604, autonomous cell section module 606 and/or the processing system 614 configured to perform the receiving means. In one configuration, the means functions correspond to the aforementioned structures. In another aspect, the aforementioned means may be a module or any apparatus configured to perform the functions recited by the aforementioned means.

Several aspects of a telecommunications system have been presented with reference to TD-SCDMA and GSM, systems, for example. As those skilled in the art will readily appreciate, various aspects described throughout this disclosure may be extended to other telecommunication systems, network architectures and communication standards. By way of example, various aspects may be extended to other UMTS systems such as W-CDMA, high speed downlink packet access (HSDPA), high speed uplink packet access (HSUPA), high speed packet access plus (HSPA+), TD-CDMA and TD-HSPA. Various aspects may also be extended to systems employing long term evolution (LTE) (in FDD, TDD, or both modes), LTE-Advanced (LTE-A) (in FDD, TDD, or both modes), CDMA2000, evolution-data optimized (EV-DO), ultra mobile broadband (UMB), IEEE 802.11 (Wi-Fi), IEEE 802.16 (WiMAX), IEEE 802.20, ultra-wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

It is also to be understood that the term “signal quality” is non-limiting. Signal quality is intended to cover any type of signal metric such as received signal code power (RSCP), reference signal received power (RSRP), reference signal received quality (RSRQ), received signal strength indicator (RSSI), signal to noise ratio (SNR), signal to interference plus noise ratio (SINR), etc.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication in a multiple subscriber identity module (SIM) user equipment (UE) comprising:
receiving a list of neighboring base stations from a serving base station of a first SIM;
identifying a serving base station of a second SIM; and
determining a final target base station for a cell reselection procedure and/or cell change order procedure from among the neighboring base stations and the serving base station of the second SIM, in which the determining includes comparing a first signal metric of a candidate target base station to a second signal metric of the serving base station of the second SIM, and selecting the candidate target base station as the final target base station in response to the first signal metric being greater than the second signal metric, or selecting the serving base station of the second SIM as the final target base station in response to the first signal metric being less than the second signal metric.

2. The method of claim 1, further comprising adding the serving base station of the second SIM to the list of neighboring base stations of the first SIM.

3. The method of claim 1, further comprising:
receiving the candidate target base station from the serving base station of the first SIM in a cell change order, the candidate target base station being different from the serving base station of the second SIM.

4. The method of claim 1, further comprising:
selecting the candidate target base station from the list of neighboring base stations by the UE in a cell reselection process, the candidate target base station being different from the serving base station of the second SIM.

5. The method of claim 1, in which the neighboring base stations and the serving base station of the second SIM are in a first radio access technology (RAT) and the serving base station of the first SIM is in a second RAT.

6. The method of claim 5, in which the first RAT is the same as the second RAT.

7. An apparatus for wireless communication, comprising:
means for receiving a list of neighboring base stations from a serving base station of a first SIM;
means for identifying a serving base station of a second SIM; and
means for determining a final target base station for a cell reselection procedure and/or cell change order procedure from among the neighboring base stations and the serving base station of the second SIM, in which the means for determining includes means for comparing a first signal metric of a candidate target base station to a second signal metric of the serving base station of the second SIM, and selecting the candidate target base station as the final target base station in response to the first signal metric being greater than the second signal metric, or selecting the serving base station of the second SIM as the final target base station in response to the first signal metric being less than the second signal metric.

8. The apparatus of claim 7, further comprising means for adding the serving base station of the second SIM to the list of neighboring base stations of the first SIM.

9. The apparatus of claim 7, further comprising:
means for receiving the candidate target base station from the serving base station of the first SIM in a cell change order, the candidate target base station being different from the serving base station of the second SIM.

10. The apparatus of claim 7, further comprising:
means for selecting the candidate target base station from the list of neighboring base stations by a UE in a cell reselection process, the candidate target base station being different from the serving base station of the second SIM.

11. The apparatus of claim 7, in which the neighboring base stations and the serving base station of the second SIM are in a first radio access technology (RAT) and the serving base station of the first SIM is in a second RAT.

12. The apparatus of claim 11, in which the first RAT is the same as the second RAT.

13. An apparatus for wireless communication, comprising:
a memory; and
at least one processor coupled to the memory, the at least one processor being configured:
to receive a list of neighboring base stations from a serving base station of a first SIM;
to identify a serving base station of a second SIM; and
to determine a final target base station for a cell reselection procedure and/or cell change order procedure from among the neighboring base stations and the serving base station of the second SIM, by comparing a first signal metric of a candidate target base station to a second signal metric of the serving base station of the second SIM, and selecting the candidate target base station as the final target base station in response to the first signal metric being greater than the second signal metric, or selecting the serving base station of the second SIM as the final target base station in response to the first signal metric being less than the second signal metric.

14. The apparatus of claim 13, in which the at least one processor is further configured to add the serving base station of the second SIM to the list of neighboring base stations of the first SIM.

15. The apparatus of claim 13, in which the at least one processor is further configured:
to receive the candidate target base station from the serving base station of the first SIM in a cell change order, the candidate target base station being different from the serving base station of the second SIM.

16. The apparatus of claim 13, in which the at least one processor is further configured:
to select the candidate target base station from the list of neighboring base stations by a UE in a cell reselection process, the candidate target base station being different from the serving base station of the second SIM.

17. The apparatus of claim 13, in which the neighboring base stations and the serving base station of the second SIM are in a first radio access technology (RAT) and the serving base station of the first SIM is in a second RAT.

18. The apparatus of claim 17, in which the first RAT is the same as the second RAT.

19. A computer program product for wireless communication in a wireless network, comprising:
a non-transitory computer-readable medium having non-transitory program code recorded thereon, the program code comprising:
program code to receive a list of neighboring base stations from a serving base station of a first SIM;
program code to identify a serving base station of a second SIM; and
program code to determine a final target base station for a cell reselection procedure and/or cell change order procedure from among the neighboring base stations and the serving base station of the second SIM, by comparing a first signal metric of a candidate target base station to a second signal metric of the serving base station of the second SIM, to select the candidate target base station as the final target base station in response to the first signal metric being greater than the second signal metric, or to select the serving base station of the second SIM as the final target base station in response to the first signal metric being less than the second signal metric.

20. The computer program product of claim 19, in which the program code further comprises program code to add the serving base station of the second SIM to the list of neighboring base stations of the first SIM.

21. The computer program product of claim 19, in which the program code further comprises:
program code to receive the candidate target base station from the serving base station of the first SIM in a cell change order, the candidate target base station being different from the serving base station of the second SIM.

22. The computer program product of claim 19, in which the program code further comprises:
program code to select the candidate target base station from the list of neighboring base stations by a UE in a cell reselection process, the candidate target base station being different from the serving base station of the second SIM.

23. The computer program product of claim 19, in which the neighboring base stations and the serving base station of the second SIM are in a first radio access technology (RAT) and the serving base station of the first SIM is in a second RAT.

24. The computer program product of claim 23, in which the first RAT is the same as the second RAT.
